(19) United States
(12) Patent Application Publication
(10) Pub. No.: US 2006/0137018 A1
(43) Pub. Date: Jun. 22, 2006

(54) Method and apparatus to provide secured surveillance data to authorized entities

(75) Inventor: Richard Dan Herschaft, Whitestone, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/285,891

(22) Filed: Nov. 23, 2005

Related U.S. Application Data
(60) Provisional application No. 60/631,328, filed on Nov. 29, 2004.
(60) Provisional application No. 60/633,527, filed on Dec. 6, 2004.

(51) Int. Cl. H04N 7/16

(52) U.S. Cl. 726/26

(57) ABSTRACT

A method and apparatus is provided for controlling a surveillance device. A recorder is configured to digitally record detected information. A privacy protection mode is selected as override mode for fully unrestricted capture of surveillance information. Otherwise, a bypass mode is selected for partially unrestricted capture of surveillance information. In bypass mode, captured information is filtered by the type of activity detected and then encrypted for access by an authorized entity. In override mode, an authorization process is used to ensure that the surveillance device remains installed in an approved location.

### CROSS REFERENCE TO RELATED APPLICATION(S)

This application claims the benefit of U.S. provisional application No. 60/631,328, filed on Nov. 29, 2004 and U.S. provisional application No. 60/633,527 filed on Dec. 6, 2004, which are incorporated by reference as if fully set forth.

### FIELD OF INVENTION

The present invention relates to surveillance devices. More particularly, the present invention relates to a method and apparatus for bypass and override of privacy mode disabling functionality in surveillance devices.

### BACKGROUND

Miniaturization is allowing devices suitable for optics and sound to exist within many objects that previously did not house such devices. Examples include cameras, microphones, and speakerphones that are now embedded within cellular telephones, PDAs, and watches. This development has created privacy issues with respect to unauthorized local recording or relaying sounds and/or images to other devices. Additionally, the embedding of these devices has affected products such as cellular telephones in that these once simple communication tools have become potential spying mechanisms that may violate the personal rights, dignity and freedoms of human beings.

To regulate such activity, restrictions regarding the use of such devices in certain areas are posted or searches for such devices are conducted. Unfortunately, the continuously diminishing size and integration of image and sound detection devices with other non-threatening devices, has made it very difficult to restrict their entry into given areas.

Alternatively, systems are used to broadcast radio frequency beacons that tell devices such as for example, camera telephones, to disable its camera function. However, in such systems, it is possible to block such signals to, for example, a telephone's antenna. Additionally, there are also camera telephone implementations in which the camera is not in an RF-communicating device (e.g. infrared data association (IrDA)). As a result, the device may not have any wireless communication capability. Additionally, since radio frequencies are usually not restricted to specific areas, they may propagate to other areas and affect devices that are not in restricted areas.

It is questionable whether a cooperative system is possible. Even if mandated by governments, the production of devices that do not contain the cooperative function can still occur, and there are ways to defeat such safe guards even if they are included in the equipment's production.

Accordingly, it is desirable to have a mechanism and method to regulate the use of image, sound, and other sensing devices/functions according to location, situations, and/or other authorization criteria without the need for cooperative functionality. If such sensing devices are embedded in a cellular telephone, it is desirable to regulate such cellular telephones using hardware technology that is in line with their mandated features and software.

As part of protecting privacy, camera sensed images can be altered or discarded. An alternate means to protect privacy concerns is to avoid capturing an image altogether.

Notwithstanding privacy concerns, it may be undesirable for an instructing device to remove or distort an unwilling subject from a sensed image. For example, the purpose of surveillance cameras is to catch unwilling subjects in the act of engaging in unlawful behavior. Thus, in some cases, the functionality of removing unwilling subjects from a sensed image will need to be disabled or handled in a special way. The same need may arise regarding other types of sensors such as, for example, sound sensing devices.

Approaches to dealing with the discarding of sensed data or more generally the disabling of privacy features in sensing devices have not been addressed. Digital Rights Management (DRM) techniques have been used to protect image and sound data, but these techniques have not been applied to privacy protected images and sounds. Accordingly, it is desirable to have a device and method for disabling functionality in a sensing device that removes unwilling subjects from sensed images while protecting the privacy of the sensed subjects.

### SUMMARY

A method and apparatus is provided for disabling privacy features of a surveillance device for authorized purposes. Digital information is captured and recorded by a surveillance device, which is processed according to a normal privacy mode and a bypass mode. The privacy mode processing includes features that disable sensing functions of the surveillance device. In parallel to this processing is a bypass mode processing which includes encryption and authorization of trusted entities that may access the captured information. A temporary storage device holds an amount of captured information. A processor analyzes the stored information to determine a presence of agitated activity detected that may indicate suspicious activity. A filter controls the flow of captured information to an encrypting device such that captured information related to suspicious activity is encrypted for subsequent access by an authorized entity. The filter may also be used to filter out detected information that is determined to be of a private nature by the processor.

The encrypting device encrypts the recorded information to prevent access to unauthorized persons and a storage device stores the encrypted information in an encrypted vault for future access by an authorized person. A decrypting device located in a secured location decrypts the encrypted information and a monitor located in a secured location is used for authorized viewing of the decrypted information.

In another embodiment, a surveillance device may be disabled. A sensing function senses a stimulus of the surrounding environment to produce captured information, which is recorded. An authorized fixed location is established for the surveillance device. A detector determines whether the surveillance device has been moved from the authorized fixed location installation. As a privacy feature, the sensing function of the device may be disabled or the captured information may be altered if movement of the surveillance device from its authorized fixed location has been detected.

### BRIEF DESCRIPTION OF THE DRAWINGS

A more detailed understanding of the invention may be had from the following description, given by way of example and to be understood in conjunction with the accompanying drawings wherein:

FIG. 1 illustrates a unwilling subject under surveillance;

FIG. 2 shows a method flowchart for mode selection of unrestricted capture of surveillance information;

FIG. 3 is a block diagram of an apparatus for providing recorded and monitored surveillance information to an authorized entity during bypass mode;

FIG. 4 shows a method flowchart for bypass mode processing of surveillance information;

FIG. 5 shows a summary diagram of a bypass mode filtering feature;

FIG. 6 shows a surveillance device with sensing function that may be disabled for privacy reasons;

FIG. 7 shows a method flowchart of an override mode processing of surveillance information; and

FIG. 8 shows an illustration of an object interrogator that may be disabled for privacy reasons.

### DETAILED DESCRIPTION OF THE PREFERRED EMBODIMENT(S)

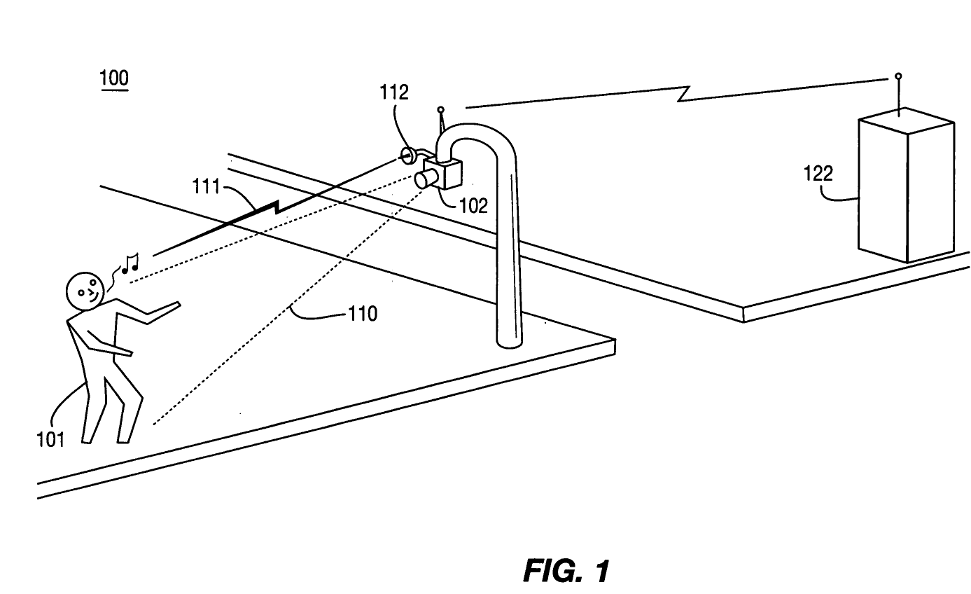

FIG. 1 illustrates surveillance of an unwilling subject using sound and image sensing by surveillance equipment. At a public location 100, an image 110 of subject 101 is sensed by a surveillance camera 102. A sound 111 is sensed by a audio recorder 112, or an equivalent sound sensing device. According to the present invention, surveillance equipment such as the camera 102 and the audio recorder 112 may be placed in public spaces such as on street corners, in subway stations, and on subways and buses for the purpose of capturing and recording unlawful activity. As part of its surveillance function, the surveillance equipment 102, 112 continually captures sounds and images of its surroundings. Although described hereafter in terms of capturing visual images and audio signals, the present invention is also applicable to any sensing device used for surveillance, including but not limited to a chemical sensing device. In a preferred embodiment, all sounds and images are retained as captured information, but not used until, for example, a crime is committed or suspected to have been committed in a certain area. In an alternative embodiment, images, sounds or portions thereof may be discarded while in a format accessible to an unauthorized person, but the discarded information is also retained in a modified format as part of a secure parallel path. Restricting access to the captured information preserves privacy rights of law abiding unwilling subjects.

The captured information may be retained within the surveillance equipment itself, or offloaded to a remote location where the surveillance device is installed with communication capability. As shown in FIG. 1, a server 122 receives the captured information by a wireless communication from the surveillance devices 102 and 112, where the information is stored and processed for future access by authorized persons. Alternatively, the captured information may be transmitted along a secured wired network.

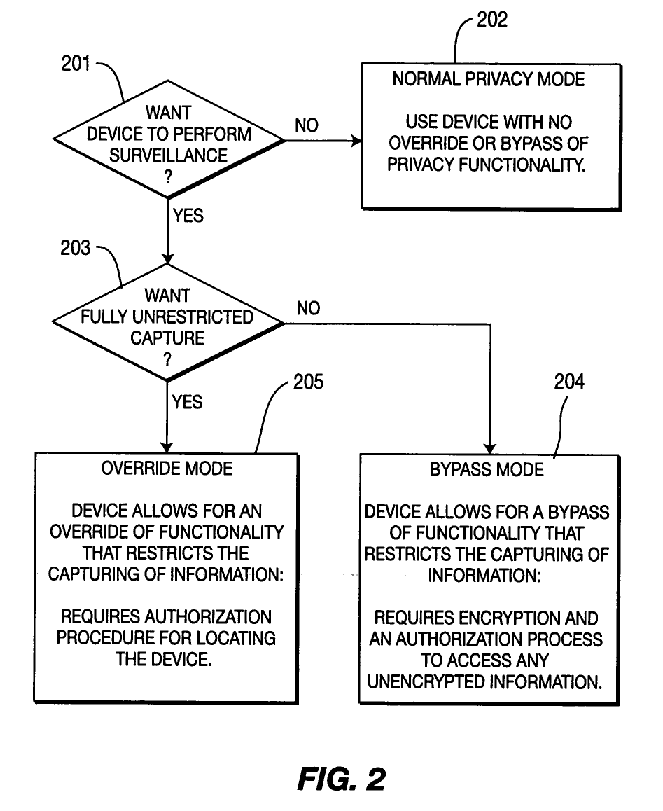

FIG. 2 shows a method flowchart for selection modes for unrestricted capture of surveillance information. In step 201, a first decision is made as to whether the surveillance device 102, 112 will be used by authorized entities to perform surveillance. If not, then a normal privacy mode is selected (step 202) such that any privacy functionality in surveillance device 102, 212 remains intact to protect the privacy of unwilling subjects by some means of restricting the capture of images or sound.

If surveillance by devices 102, 112 is authorized, then the next decision is as to whether the capture of surveillance information is to be fully unrestricted (step 203). If so, then an override mode is selected (step 205), where the surveillance device 102, 112 is able to override any privacy functionality. For example, a disabled state of image capturing is overridden. Also, the location of such a surveillance device will be preceded by an authorization procedure to ensure that only images and sounds at authorized locations are captured. The authorization procedure is described in further detail in a later section below.

If there is not to be fully unrestricted capture of surveillance information, then a bypass mode is selected in step 204, in which surveillance device 102, 112 allows for a bypass of the privacy functionality restricting capture of images and sounds. During bypass mode, the captured information is encrypted and an authorization process is followed to access any unencrypted information.

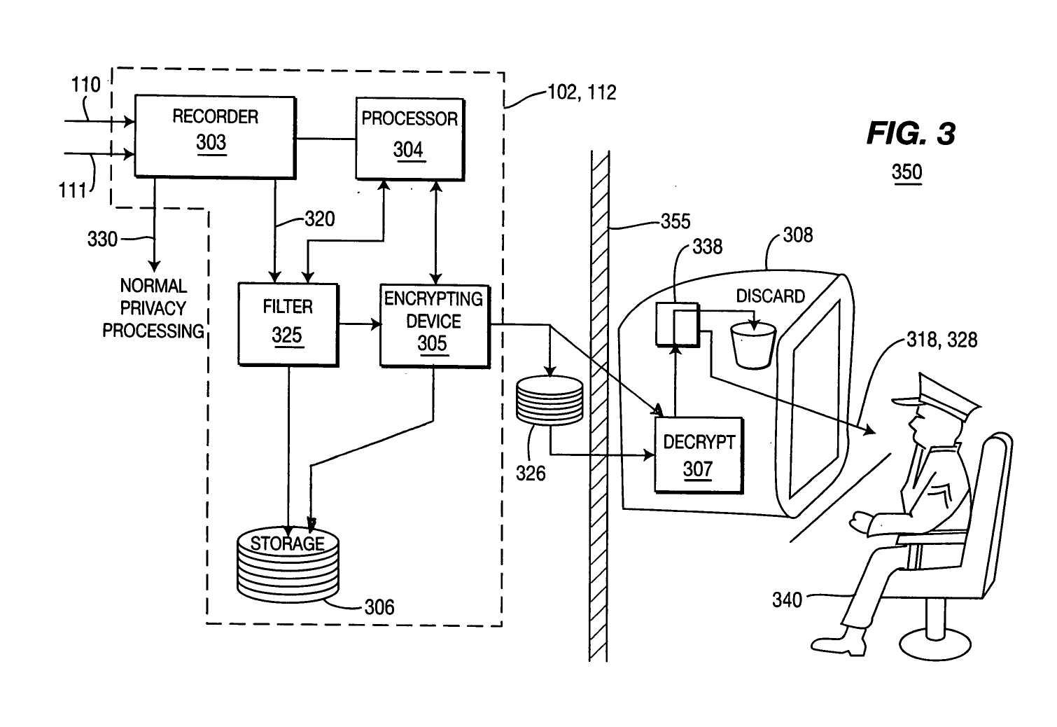

FIG. 3 shows a block diagram of the processing of the surveillance data for a bypass mode of a surveillance device's privacy functions. The captured information is also displayed on monitors that are viewed in real time by authorized entities, or after some delay by retrieving the stored data. Storing surveillance data is performed by a digital recorder 303, a secure processor 304, an encrypting device 305, a temporary storage device 306, which are preferably contained within the surveillance equipment 102, 112. Alternatively, some or all of these devices are remotely located, for instance at the remote server 122 (FIG. 1). An encryption storage device 326 is preferably located external to the surveillance device 102, 112.

Surveillance data, such as an image 110 and a sound 111, is received by the digital recorder 303, which is controlled by the processor 304. In a preferred embodiment, the processor 304 controls whether the recorded data is sent along one of two parallel signal paths 320, 330 which are established to maintain privacy while allowing the security function of the surveillance camera 102 to proceed. Signal 320 is preferably processed by a filter 325, which is used to filter-in captured information believed to be suspicious in nature and/or filter out captured information determined to be of a private nature. Alternatively, the captured information is unfiltered, and protection of the captured information is totally a function of encryption. Secure temporary storage device 306, in conjunction with filter 325 and processor 304, permits processing and analysis of the captured information for determining its nature and then whether it should be filtered in or filtered out. Preferably, once the captured image or sound information is filtered, then encrypting device 305 performs encryption on the filtered information, according to a preferred method which will later be described in further detail. This sequence of encryption and filtering is according to an implementation where the temporary storage is relatively for a short duration. Alternatively, should the implementation require longer periods of temporary storage for adequate filtering processing, then the information is encrypted by encryption device 305 prior to being stored in device 306 in order to ensure protection of the captured information. Storage device 326 receives the encrypted information and retains the stored information as an encrypted vault until ready to be accessed by an authorized entity 340. The authorized entity 340, such as a security officer, a law enforcement official, or the like, performs monitoring of the surveillance image data 318 and sound data 328 at monitor 308. A decrypting device 307 contains a private encryption key or keys so that the protected data can be accessed by the authorized person 340. A timed temporary memory device 338, preferably a first in first out (FIFO) memory type, stores the decrypted information temporarily so that the information can be replayed if desired by the authorized entity 340. Since the decrypted information is at risk of interception, the information is stored in the memory device only for a short duration, and is then discarded.

Where multiple monitors 308 are installed, each monitor 108 shall be accompanied by its own decrypting device 307, each with its own private key. A corresponding certificate containing a public key and information identifying the monitor is used to prove the monitor's authorized identity to the surveillance device 102, 112. The public/private keys are also used to protect a symmetric session key that will be used for the image data transmission. Preferably, the session key is periodically updated so that the data protected by a particular key will be limited.

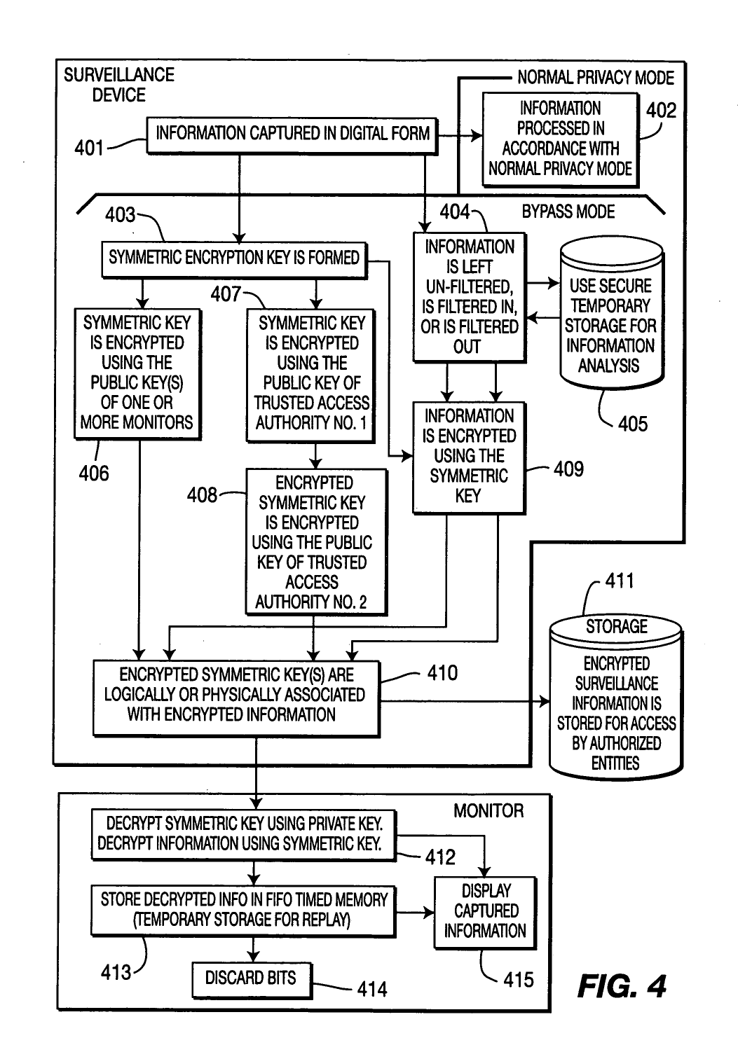

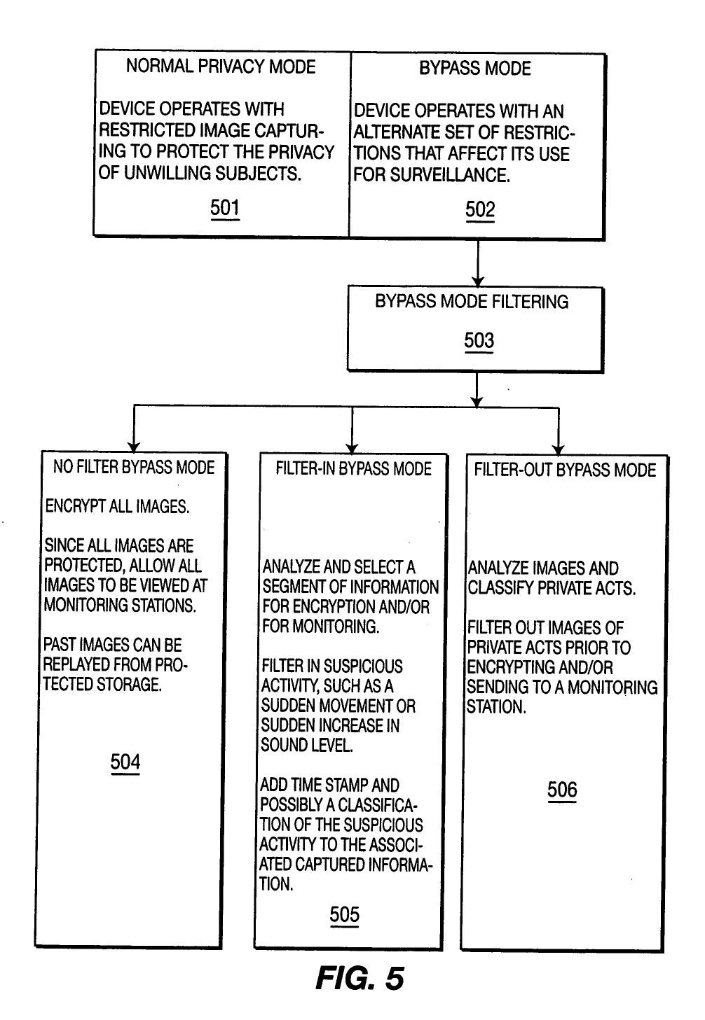

FIG. 4 shows a method flowchart for bypass mode according to the apparatus shown in FIG. 3, more particularly describing the encryption feature. The surveillance device digitally captures the information (step 401) and the information can be processed in parallel paths for the normal privacy mode (step 402) or the bypass mode of operation. During the bypass mode, the filtering decision occurs in step 404, whereby the captured information is unfiltered, filtered in, and/or filtered out. More detail with respect to the filtering during bypass mode will be described with reference to FIG. 5.

In a parallel process, a symmetric encryption key is formed in step 403. The symmetric key is encrypted in step 406 using a public key of each monitor 308. The symmetric key is also encrypted using the public key of a first trusted access authority (step 407), which is in turn further encrypted using a public key of a second trusted access authority (step 408). (Note that there can be one or more than two trusted access authorities, in which case the encryption with public keys would accommodate the number of trusted access authorities in a tandem manner, accordingly.) The filtered information is encrypted by the symmetric key in step 409. In step 410, the encrypted keys are logically or physically associated with the encrypted information. The resulting encrypted information is now protected and can be delivered to the encryption storage device (step 411) and any connected monitors.

Alternatively, more than one symmetric key can be formed in step 403, such that a different symmetric key is used in steps 406 and 410 for the information that is sent to a monitor than that used in steps 407-410 for the information sent to encrypted storage. Also, a high rate of change is preferred for the symmetric key, but this is weighed against the increased processing load as a result.

At step 412, the symmetric key is decrypted using the monitor's private key and the information is decrypted using the decrypted symmetric key. Since each monitor has its own private key, different information can be sent to different monitors. The image or sound information can now be viewed or heard at a display terminal (step 415). Additionally, the decrypted information is temporarily stored at the monitor for possible replaying by the authorized entity (step 413), and then discarded (step 414).

While the preferred method of encryption is described herein, the present invention can also work with other methods that maintain the confidentiality of the information as it is transported to a monitor. As shown in FIG. 4, there are fixed rights where the data can be displayed immediately and recently received data that is still in a timed memory (a FIFO is shown) can be replayed. Alternatively, the present invention can use the DRM technique of assigning usage rights to information so that there is flexibility in how the data is sent to and accessed at a plurality of monitors.

FIG. 5 shows a summary diagram for the bypass mode filtering function performed by filter 325. As mentioned, a surveillance device can operate in a normal privacy mode 501 in which image and sound capturing is restricted to protect privacy of unwilling subjects, while at the same time the device may operate in a bypass mode 502 in which such restrictions are bypassed in a parallel information processing path according to a set of alternate restrictions that permit authorized entities to access the surveillance information in a secure fashion. There are three preferred variations for the bypass mode filtering 503 that can be applied alone or in combination. These are no filtering bypass mode 504, filter-in bypass mode 505, and filter out 506.

In the unfiltered bypass mode 504, all captured images and sounds are encrypted so that only a trusted authority can allow for the images to be accessed upon decryption. The captured images and sounds are protected by DRM or conditional access techniques, and thus are allowed to be viewed at secure monitoring stations. The decrypted information at the monitoring stations cannot be recorded in a decrypted format, but may be replayed from protected temporary storage that is discarded after a predetermined short life span. Encrypted storage of the information under the control of a DRM system may also be allowed at the monitoring stations.

In the filter-in bypass mode 505, a predetermined amount of captured information, for example 10 seconds worth of images to several days worth of images, is kept in secure non-encrypted or encrypted storage, depending on the expected duration of storage, so that intelligent image/sound processing software can analyze a stream of images and select a segment of the stream for encryption and/or for monitoring. For longer duration storage, the information is encrypted prior to storage. The processor 304 is preferably configured to receive a trigger signal initiated by detected images of sudden movement by a subject within the sensing range of the surveillance device (e.g., a quick change in the pattern of pedestrian and vehicular traffic) or by sounds with a sharp increase in volume (e.g., screams or shouts). Such indications can be analyzed to determine the type of activity captured by the surveillance device. The captured information can be classified as a normal or an agitated category, the latter indicating suspicious activity. Additionally, the captured information may be marked by a time stamp and/or a location stamp, as well as the activity type, which would be useful for searching, indexing and archiving purposes.

In the filter-out bypass mode 506, a predetermined amount of captured information is saved for analysis by intelligent image/sound processing software so that certain acts that may be officially classified as private acts and then can be filtered out or obfuscated prior to the stream of images/sounds being encrypted and/or sent to a monitoring station. A designated official or lawful entity is entrusted with specifying which activities are considered private and should be filtered out. The required algorithms or their implementation in code or pseudo code to perform the filtering can be provided by or promulgated by the official or lawful entity. Since filtering out content restricts the capture of information, this approach overlaps with the normal privacy mode 501.

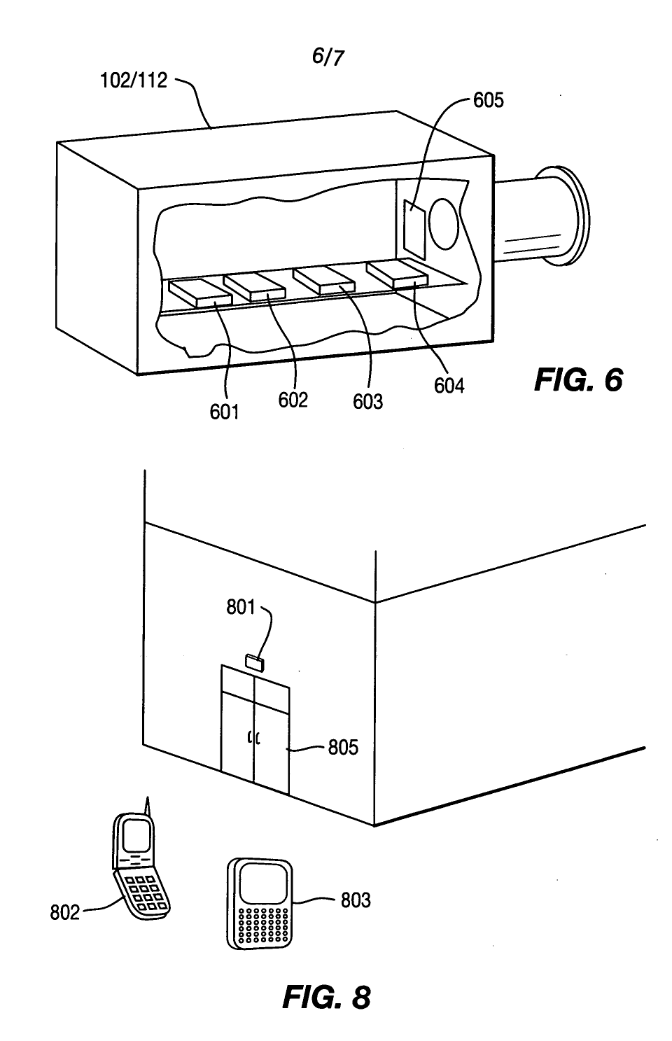

FIG. 6 illustrates an implementation for the override mode, wherein the surveillance camera 102 or audio recorder 112 is assigned to a fixed location for authorized surveillance of that location. If the camera 102 or audio recorder 112 is moved from this location, its sensing, capturing and/or reporting functionality is disabled or its privacy features are enabled if not already activated. For instance, if the surveillance device 102, 112 is moved from its fixed location, a stimuli sensor 605, such as a camera's light sensor or image focus function, or a audio recorder's sound sensor, is disabled to prevent unauthorized surveillance of unwilling subjects and thereby preserving privacy interests. A change in the fixed location of surveillance device 102, 112 can be determined by a global positioning system (GPS) signal processor 601 or through the use of an internal motion sensor 602 embedded in the surveillance device 102, 112.

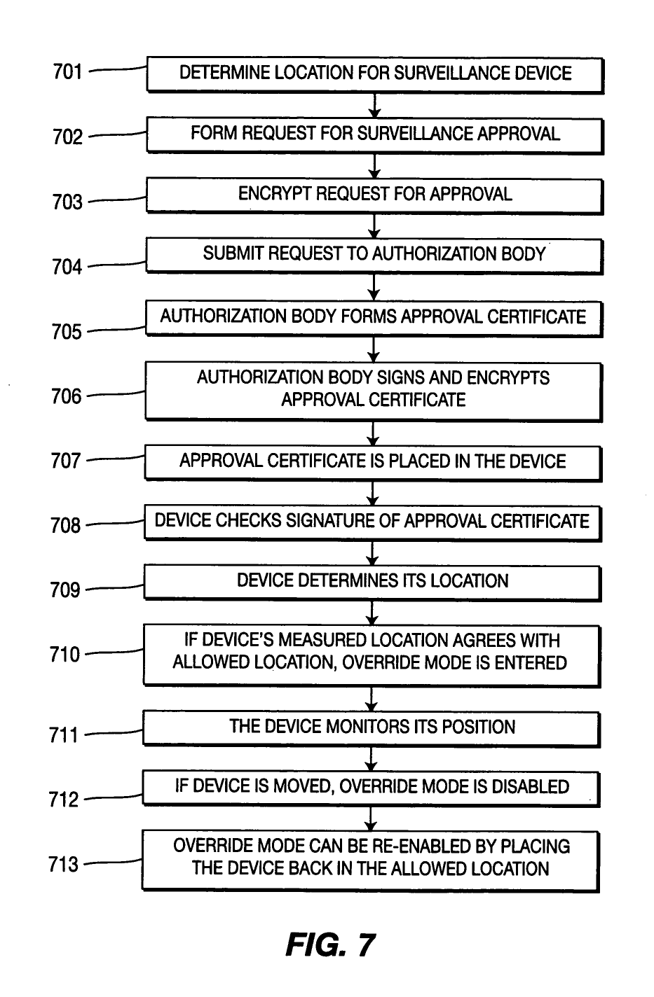

FIG. 7 shows a method flowchart for the override mode. In step 701 the location coordinates for the placement of the surveillance device is determined, preferably by GPS, or a similar mechanism. In step 702, a request is formed for the operation of the surveillance device in override mode. The request should include one or more of the following: the device's location, a certificate of the surveillance device's public key, a time period during which surveillance will be performed (can be seconds to years), and a reason why surveillance needs to be performed. The request may include an affidavit that the device will be used according to the law at a specified location for the purposes of protecting life and/or property. The affidavit is preferably submitted via the internet and the information in it can be verified by the proper authorities by checking property records, follow-up telephone confirmation, and/or postal mail confirmations.

To maintain the confidentiality of the surveillance request, it is encrypted in step 703 using the public key of the authorization entity (the root public key for a chain of trust of public key certificates is securely embedded in the device with integrity protections). The authorization entity or authorization body may include a court of law, state or municipal police, federal law enforcement officials, or any similar government authority or organization. In step 704, a request for surveillance is submitted to the authorization entity, using the web site of the authorization entity, where a TLS connection can provide the encryption for confidentiality, or using a web service for the direct messaging between the surveillance device and the authorization entity. If approved, in step 705 the authorization entity forms the approval certificate consisting of at least: the allowed location and the allowed time period. It may also include: the allowed reason for surveillance, and the allowed tolerance for the measured location coordinates. In step 706, the authorization body signs the approval certificate with its private key and encrypts it with the public key of the surveillance device. The message is digitally signed by a person or an organization who is granted the lawful authorization to allow the overriding of the sensor disabling privacy features at a recording device. The signed message may include an expiration date, whereby the authorized person or organization must reapply for authorization to engage the surveillance device. The authorization is stated in a digital certificate that accompanies the signature. A root certificate issued by a governmental or quasi-governmental body is preferably embedded in memory 603 or downloaded to memory 603 of each surveillance device 102, 112. This mechanism in the recording device must be tamper proof. By packaging the approval certificate with the encrypted information, it can be shown that it was obtained lawfully and can be submitted to a court of law as the certificate is permanently linked to the information. This packaging can be achieved by encrypting the captured information together with the certificate identification. An alternative method is to apply the certificate as a watermark to the captured information, using known digital watermarking techniques. To maintain the integrity of this association, the metadata and the sensed data should be digitally signed using a private key of the surveillance device.

The approval certificate is next placed in the surveillance device preferably through a web service reply message (step 707). The message will contain the device's identity, the allowed location, and a unique (one time) sequentially incrementing number. The one time number is saved by the recording device so that it can detect if an attempt is being made to re-enter a signed message.

In step 708, the surveillance device checks the signature of the certificate using a trusted root public key embedded in its secure processor (along with a possible certificate chain sent with the approval). In step 709, the surveillance device determines its location using an embedded GPS receiver, a separate trusted GPS receiver that can be physically attached to the device, or any equivalent mechanism to determine its truthful location. In step 710, the secure processor in the surveillance device determines if its measured location is within the allowed tolerance specified for the allowed location. If it is, the surveillance device disables the functionality that restricts the capturing of images or sounds. The surveillance device is now in override mode.

In step 711, the surveillance device continuously or periodically monitors its position. This can be done with an embedded GPS receiver or a self contained motion detector that can filter out normal camera panning motion. In step 712, the override mode is disabled if the surveillance device is moved and the functionality that causes the restricted capturing of images or sounds is enabled. Alternatively, the functionality that allows for images to be captured can be disabled. In an additional embodiment, the override mode is disabled if the authorized time period for surveillance according to the approval certificate has expired. This can be implemented by using an internal secure real time clock, or a tick counting mechanism as can be supplied by Trusted Computing Group's Trusted Platform Module.

Finally, in step 713, the override mode for the surveillance device can be re-enabled by placing the device back in the allowed location and using the unexpired allowance certificate or by requesting a different allowance certificate for a different location.

If the surveillance device must be moved to another location, the above described procedure must be followed again. The same technique can be used with other sensing devices, such as those described below, with slight modifications.

An example of an implementation of the above authorization procedure for the override mode is to provide a technical control over wiretaps or similar surveillance by law enforcement. For instance, a police officer who has been authorized to install a surveillance device would install a court authorized approval certificate directly in the device (e.g., a camera or audio recorder) in order to perform the electronic surveillance.

Another example of an implementation for a surveillance device in a privacy mode versus an override mode is as follows. In the normal privacy mode for a surveillance device, its sensing function has been disabled and it is stored in a law enforcement agency's stock room. Following a request for override mode, a court order is issued, and an authorized approval certificate is issued. This certificate which can restrict the sensing device to operate in a certain location, or during a certain period of time, or both, is installed in the sensing device which is designated in the certificate. The sensing device can then enter the override mode which in this case means that it goes from a disabled state of sensing to an enabled state of sensing. This example can be extended from a law enforcement agency to any party that would like to set up a surveillance device, although typically in this case, the device when entering override mode will go from a state of somewhat restricted sensing to a state of fewer or no restrictions (other than being limited by location and/or time).

The following sensing and reporting functions for surveillance device 102, 112 are examples of what may be enabled or disabled if the device 102, 112 is removed from its authorized fixed location: recording functions, notification or alerting systems either local or remote, data distortion, downsampling ability, transfer of the captured information, auditing, watermarking or fingerprinting.

With respect to data distortion, camera image blurring may be used to address the unwanted sensing of images with cameras. For instance, an interference mechanism may operate against the auto-focusing mechanism in image sensing devices (e.g., cameras) so that a sensed image is blurred. Copending application entitled Method and Implementation for Using Infrared Signals and Sonar to Interfere with Camera Autofocus Mechanism, describes continuous or intermittent emitters to confuse the auto focusing mechanisms in cameras. These emitters can cause sensed images to be blurred and unusable. Multiple infrared emissions of varying intensities will also cause under-exposure or over-exposure lighting in sensed images. Such emitters can be manually controlled to intentionally alter captured surveillance information as a privacy feature, by manual entry of codes, restricting operation to occur only by devices having a security decoding means, and/or logging onto a network or access point with appropriate authentication and access codes to obtain access to enablement information. This manual control may be overridden if the camera if moved from its authorized location.

Wireless communication between the surveillance device 102, 112 and a wireless transceiver creates a mechanism for automatically reporting events that require attention by setting up a call to a call processing center or a specified phone number. For example, a mobile phone can automatically receive information sent by a transmitter 604 within surveillance device 102, 112 when a security breach or unlawful activity is detected. Location of the surveillance device 102, 112 is also transmitted to assist with emergency response. Communication between the surveillance device 102, 112 a mobile phone can occur over infrared (IR), Bluetooth, or any other wireless or wired interface. The reporting of a sensor may be periodic or only when a sensor detects a situation within a pre-determined operating range. If surveillance device 102, 112 is moved from its authorized fixed location, such communication functionality is disabled, such as by disabling transmitter 404.

FIG. 8 shows an alternative embodiment in which an object interrogator 801 installed on a doorway 805 for monitoring objects 802, 803 equipped with electronic tags. Rather than a surveillance camera or audio recorder, the sensing apparatus with privacy features is implemented here as an object interrogator that monitors sets of objects that are to be managed within its interrogation range under specific circumstances. These circumstances include location, time of day, day of the week, environmental conditions, and any other determinable status that influences the inclusion or exclusion of objects. The monitored objects have embedded electronic tags used to identify the various objects. The tags may be simple identifiers of the existence of an object with little or no processing capabilities. Conversely, the tags may be devices capable of processing and/or exchanging information with object interrogators (e.g. PDAs, cellular telephones, smart cards, or the like). Protection of such tagged items to be identified may include a mechanism so as not to allow such items to be removed from a predefined area. For example, a tagged item could be detected by the loss of its signal by its interrogator, by movement of the tagged item out of the predefined area, or by the tagged item crossing a portal at a boundary for the predefined area. The possessor, the carrier, and/or some other person or entity is informed of the occurrence and appropriate action can be taken.

As shown in FIG. 8, an object interrogator 801 is implemented as a portal identifier for a doorway 805, which interrogates devices within its particular range of detection. While crossing a threshold is one particular implementation, being within communication range of a device or devices may also be used to define an area. While each of the above sensing devices are described as functioning as individual components, it is also possible that a single component may perform the functions as either tag or object interrogator. For example, a telephone can function as an object interrogator and as a tag to another object interrogator. Any portal identifier as described above would be applied to the fixed location procedure described for the surveillance device 102, 112, whereby the interrogator is preauthorized for its location, and movement from that location would disable it.

Although the features and elements of this embodiment are described in particular combinations, each feature or element can be used alone (without the other features and elements of the preferred embodiments) or in various combinations with or without other features and elements of the present invention.

What is claimed is:

1. A method for secure processing of digital information captured by a surveillance device for authorized purposes, comprising:
recording digital information captured by a surveillance device, where the digital information is a representation of a visual image or an audio signal;
processing the recorded information according to a privacy mode that inhibits access to the information or alters the information for protection of privacy interests; and
processing the recorded information according to a bypass mode in parallel with the privacy mode, where the bypass mode processing bypasses the processing according to the privacy mode, the bypass mode including encrypting the recorded information and authorizing an authorized entity to have access to the encrypted information in a decrypted format.

2. The method of claim 1, wherein the processing according to the bypass mode further comprises:
storing the encrypted information in an encrypted storage device.

3. The method of claim 2, further comprising:
decrypting the digital information by a decrypting device; and
displaying the decrypted information at a secure monitor accessible only to the authorized entity.

4. The method of claim 3, wherein the encrypting comprises embedding a public key into the surveillance device and the decrypting comprises using at least one private key at the decrypting device.

5. The method of claim 4, wherein the private key comprises a plurality of keys.

6. The method of claim 5, wherein the plurality of keys are applied in a tandem manner, such that a first encryption is performed with a first key and the first encryption is subsequently encrypted by a second key to produce a second encryption.

7. The method of claim 6, wherein N keys are applied in a tandem manner, such that an Nth encryption is produced by an Nth key.

8. The method of claim 3, wherein the displaying is performed in real time.

9. The method of claim 3, wherein the displaying is delayed and the decrypted information is retrieved from the encrypted storage device.

10. The method of claim 1, further comprising:
storing the recorded information in a temporary storage device;
analyzing the stored information of the temporary storage device for an indication of agitated activity captured by the surveillance device; and
selecting information for encrypting that is determined to indicate agitated activity.

11. The method of claim 10, wherein the determination of an agitated activity is based on detection of a sudden movement or a sharp increase in sound volume within the sensing range of the surveillance device.

12. The method of claim 11 further comprising:
marking the recorded digital information with a time stamp and a location at which the recording occurs.

13. The method of claim 1, further comprising:
determining an agitated type of activity recorded by the surveillance device by an automatic process which analyzes the digital information for distinguishable characteristics including at least one of the following: a sudden change in an observed pattern, a movement, a loud sound, and a scream.

14. The method of claim 1, wherein the performing security processing is triggered by a positive determination that the type of activity recorded is agitated, otherwise the digital information is discarded.

15. A method for processing information captured by an authorized surveillance device, comprising:
capturing image or sound information from a surveillance device;
establishing at least one privacy protection feature in the surveillance device, including disabling a sensing function of the surveillance device;
selecting a mode of privacy protection for the captured information, such that for fully unrestricted capturing, an override mode is selected that disables the privacy protection feature, and for partially restricted capturing, a bypass mode is selected that engages alternative protection of the captured information, including encryption of the information.

16. The method of claim 15, wherein the override mode comprises an authorization procedure for installing the surveillance device in a particular location.

17. The method of claim 16, wherein the authorization procedure comprises:
determining physical coordinates of the installation location for the surveillance device using GPS;
requesting an override mode operation for the surveillance device including at least one of the following: the device's location, a certificate of the surveillance device's public key, a time period during which surveillance will be performed, and a reason why surveillance needs to be performed.

18. The method of claim 17, wherein the request further includes an affidavit that the device will be used according to the law and for the purpose of protecting life or property.

19. The method of claim 17, wherein the request is submitted to an authorization entity via the internet.

20. The method of claim 17, wherein the authorization procedure further comprises:
encrypting the request using a public key of the authorization entity.

21. The method of claim 20, further comprising:
submitting the request to the authorization entity using a web site of the authorization entity.

22. The method of claim 16, wherein the authorization procedure further comprises:
forming a digital approval certificate including an allowed location for installation of the surveillance device and an allowed time period for operation of the surveillance device in override mode

23. The method of claim 22, further comprising:
signing the approval certificate a private key of the authorization entity; and
encrypting the approval certificate with a public key of the surveillance device.

24. The method of claim 23, wherein the approval certificate is encrypted with the captured information such that the certificate is permanently linked to the captured information.

25. The method of claim 23, wherein the approval certificate is linked with the captured information by applying a digital watermark to the information such an identification of the certificate is permanently linked to the captured information.

26. The method of claim 23, further comprising:
placing the approval certificate in the surveillance device through a web service reply message, including a unique sequentially incremented number to prevent an attempt to re-enter a signed message.

27. The method of claim 16, further comprising:
confirming the installed location using an embedded detector within the surveillance device;
periodically monitoring the installation position; and
disabling the override mode if the monitoring determines that the surveillance device has been moved form the approved location.

28. The method of claim 27, wherein the override mode is disabled if an amount of time has elapsed that is longer than the approved time for performing the surveillance in override mode.

29. The method of claim 27, wherein the embedded detector is a GPS receiver.

30. The method of claim 27, wherein the embedded detector is a motion sensor.

31. The method of claim 27, wherein the override mode is re-enabled if the surveillance device is reinstalled in the approved location.

32. A surveillance apparatus, comprising:
a surveillance device configured to detect information in the form of an image, a sound or a chemical;
a recorder configured to digitally record detected information;
a filtering mechanism configured to filter-in recorded information determined to relate to suspicious activity or filter-out information determined to relate to private activity, or a combination thereof, the filtering mechanism comprising a processor and a storage device;
an encrypting device which encrypts the filtered information; and
an encrypted storage device for storing encrypted information.

33. The apparatus of claim 32, wherein the filtering mechanism determines private activity to be filtered-out by using an embedded algorithm, code, or pseudo code.

34. The apparatus of claim 32, wherein the filtering mechanism determines private activity to be filtered-out by using a software component or application.

35. The apparatus of claim 32, further comprising:
a decrypting device located in a secured location configured to decrypt the encrypted information; and
a monitor located in a secured location for viewing the decrypted information.

36. The apparatus of claim 35, wherein the decrypting device decrypts information in real time.

37. The apparatus of claim 35, wherein the decrypting device decrypts encrypted information stored in the storage device.

38. A system comprising the apparatus of claim 32, further comprising:
a transmitter for transmitting the encrypted information to a remote location;
a remote server for receiving the encrypted information, wherein the remote server includes a remote storage device for storing the encrypted information.

39. The apparatus of claim 32, wherein the surveillance device is a camera.

40. The apparatus of claim 32, wherein the surveillance device is an audio recorder.

41. The apparatus of claim 32, wherein the surveillance device is a portal identifier type object interrogator.

42. The apparatus of claim 32, wherein the surveillance device is a chemical detection device.
